(19) United States
(12) Patent Application Publication
(10) Pub. No.: US 2022/0017761 A1
(43) Pub. Date: Jan. 20, 2022

(54) INKJET INK

(71) Applicant: NORITAKE CO., LIMITED, Nagoya-shi, Aichi (JP)

(72) Inventors: Tomoshi Kumazawa, Nagoya-shi, Aichi (JP); Hiromichi Hayashi, Nagoya-shi, Aichi (JP); Yuuki Arakawa, Nagoya-shi, Aichi (JP)

(21) Appl. No.: 17/432,687

(22) PCT Filed: Dec. 27, 2019
(86) PCT No.: PCT/JP2019/051398

§ 371 Date: Aug. 20, 2021

(30) Foreign Application Priority Data
Feb. 27, 2019 (JP) 2019-034700

(51) Int. Cl. C09D 11/322; C09D 11/101; C09D 11/107; C09D 11/037; B41M 5/00; B41M 7/00

(52) U.S. Cl. CPC C09D 11/322; C09D 11/101; B41M 7/009; C09D 11/037; B41M 5/0023; C09D 11/107

(57) ABSTRACT

The inkjet ink disclosed herein includes an inorganic solid portion including an inorganic pigment and glass and a monomer component having a photocurability. The ink is configured such that a volume of the inorganic solid portion when a total volume of the inkjet ink is 100 vol % is 30 vol % or less, and a volume of the glass when the total volume of the inorganic solid portion is 100 vol % is 78 vol % or more.

### BACKGROUND OF THE INVENTION

### Technical Field

The present invention relates to an inkjet ink. Specifically, the present invention relates to an inkjet ink used for an inorganic base material that is to be baked. The present application claims priority from Japanese Laid-open Patent Publication No. 2019-034700 filed on Feb. 27, 2019, the entire disclosure of which is incorporated by reference herein.

### Background Art

Conventionally, inkjet printing has been used as one of printing methods for drawing a desired image, such as a pattern, a character, or the like, on a printing target. The inkjet printing is used in various fields because inkjet printing allows drawing a highly precise image by a simple and reasonable device. In recent years, use of the above-described inkjet printing when drawing an image on an inorganic base material, such a ceramic base material (for example, a ceramic, a ceramic tile), a glass base material, a metal base material, or the like, has been examined. Specifically, in the field of the inorganic base material, conventionally, hand drawing, plate printing, or the like has been performed when drawing a pattern, a character, or the like. However, in view of increase in productivity, inkjet printing attracts attention because, unlike hand drawing, inkjet printing does not require skilled artisan techniques and, unlike plate printing, inkjet printing allows on-demand and quick printing.

However, there is ample room for improvement of inkjet printing in the field of inorganic base material. Because, it is difficult to apply a technique of inkjet printing in other fields in which paper, fabric, or the like is a printing target to the field of the inorganic base material as it is. For example, as for a product (inorganic product) using an inorganic base material, baking treatment is performed on an inorganic base material on which an image is drawn at 500° C. or more (for example, 500° C. to 1200° C.) in some cases. In this baking treatment, with use of an inkjet ink used for paper, fabric, or the like, there is a probability that pigments are discolored (or decolored) during the baking treatment. Therefore, an inkjet ink (inkjet ink for an inorganic base material) used for an inorganic base material that is to be baked is required to have a composition considering the baking. Examples of the inkjet ink for an inorganic base material include inks described in Patent Documents 1 and 2 or the like.

A curved surface, recesses and projections, or the like are formed on a surface of an inorganic base material that is a printing target in some cases. When trying to draw an image directly on a surface of an inorganic base material having such a curved surface or the like, distortion of a line or the like occurs. As a result, it is possible that clarity of an image is remarkably reduced or a desired image cannot be drawn. Therefore, when drawing an image on an inorganic base material having a curved surface or the like, a transfer paper for an inorganic base material (which will be also hereinafter referred to merely “transfer paper” occasionally) may be used. Specifically, a desired image is drawn on a transfer paper, the transfer paper is bonded while the transfer paper is curved in accordance with the curved surface of the inorganic material or the like. As a result, the image on the transfer paper is transferred to the inorganic base material. In drawing of an image on the transfer paper, screen printing has been used but, from a viewpoint of increasing productivity, use of inkjet printing has been proposed in recent years. One example of a technique for forming transfer paper for an inorganic base material using inkjet printing is disclosed in Patent Document 3.

### CITATION LIST

### Patent Document

PATENT DOCUMENT 1: International Patent Publication No. WO2007/80779

PATENT DOCUMENT 2: Japanese Laid-open Patent Publication No. 2017-75251

PATENT DOCUMENT 3: Japanese Laid-open Patent Publication No. 2009-154419

### SUMMARY OF THE INVENTION

### Problem to be Solved by Invention

As described above, in the field of the inkjet ink for an inorganic base material, various inks have been proposed as described in Patent Documents 1 to 3. However, due to increased demands for quality of inorganic products in recent years, it is desired to develop an ink using which a more beautiful image can be precisely drawn.

In view of the forgoing, the present invention has been devised, it is a major object of the present invention to provide an inkjet ink in which an image (decorative portion) having a beautiful gloss can be precisely formed on an inorganic base material. It is another object of the present invention to provide a method that allows stably producing an inorganic product having the decorative portion (with excellent quality stability).

### Solution to Problem

The present inventors focused on a glass component in an inkjet ink in order to form an image having a beautiful gloss on an inorganic base material. The glass component has a function of fixing an inorganic pigment on a base material surface by solidifying the glass component after being melted by baking. The present inventors devised that, by increasing a content of this glass, a surface of the inorganic pigment is properly coated with the glass to cause a beautiful gloss to appear on the image after baking. However, when the content of the glass was actually increased, another problem arose in which an ink viscosity was largely increased, a discharging performance of discharging an ink from an inkjet device was reduced, and it was difficult to draw a precise image. In order to solve the above-described problem, as a result of experiments and examinations repeatedly conducted by the present inventors, the present inventors found that an increase in the ink viscosity was not caused by an increase in the content of the glass but by an increase in a content of a whole inorganic solid portion including the inorganic pigment and the glass. Then, the present inventors found based on the finding that, with a total amount of the inorganic solid portion with respect to a total amount of the ink suppressed to a certain amount or less, even when the content of the glass is increased, the ink viscosity can be maintained at a low level. Furthermore, because there are many types of inorganic pigments and glass and respective specific gravities thereof vary, the present inventors thought that it is not a “weight” of the inorganic solid portion but a “volume” thereof that affects the ink viscosity, reached an idea of adjusting respective amounts of the inorganic solid portion and the glass in terms of volume percent, and thus, completed the present invention.

An inkjet ink disclosed herein was devised based on the above-described finding and is used for an inorganic base material that is to be based. The inkjet ink includes an inorganic solid portion including an inorganic pigment and glass, and a monomer component having a photocurability. In the inkjet ink disclosed herein, a volume of the inorganic solid portion when a total volume of the inkjet ink is 100 vol % is 30 vol % or less, and a volume of the glass when a total volume of the inorganic solid portion is 100 vol % is 78 vol % or more.

As described above, in the inkjet ink disclosed herein, a content of the inorganic solid portion in the whole ink and a content of the glass in the inorganic solid portion are properly adjusted in terms of volume. Therefore, according to the inkjet ink disclosed herein, a gloss and a discharging performance after baking can be achieved at a high level and a beautiful image can be precisely drawn on the inorganic base material.

In a preferred aspect of the inkjet ink disclosed herein, the volume of the inorganic solid portion when the total volume of the inkjet ink is 100 vol % is 5 vol % or more. Thus, both a gloss and a color developing property after baking can be preferably achieved.

In a preferred aspect of the inkjet ink disclosed herein, the volume of the glass when the total volume of the inorganic solid portion is 100 vol % is 91 vol % or less. Thus, an image on which a preferable color developing property is exhibited after baking can be formed.

In a preferred aspect of the inkjet ink disclosed herein, the monomer component includes at least a monofunctional acrylate monomer containing one acryloyl group or methacryloyl group in a molecule, a monofunctional N-vinyl compound monomer in which one vinyl group bonded to a nitrogen (N) atom of a nitrogen-containing compound, and a polyfunctional vinyl ether-based monomer containing at least two vinyl ether groups in a molecule. Thus, by using a photocurable monomer component including the three types of monomers, an image that can be preferably fixed on a surface of a printing target and having an excellent flexibility after fixing can be drawn.

In the aspect including the above-described three types of monomers, a volume ratio of the monomer component when the total volume of the inkjet ink is 100 vol % is 44 vol % or more and 85 vol % or less. Thus, both a fixing property to a surface of a printing target and a flexibility after fixing can be achieved at a high level, and an image (decorative portion) having an excellent gloss and an excellent color developing property after baking can be formed.

According to the present invention, a method for producing transfer paper for an inorganic base material used for an inorganic base material that is to be baked is provided. The method for producing transfer paper for an inorganic base material includes depositing the inkjet ink including the above-described three types of monomers on a surface of a mount by an inkjet device, and irradiating the surface of the mount with an ultraviolet ray to cure the inkjet ink deposited on the surface of the mount. According to the method for producing transfer paper for an inorganic base material, transfer paper for which a crack in an image (ink after curing) when the transfer paper is curved is preferably prevented from being generated can be produced.

As another aspect of the present invention, a method for producing an inorganic product having a decoration portion is provided. The method for producing an inorganic product includes depositing the inkjet ink disclosed herein on a surface of an organic base material, and baking the inorganic base material under a condition where a highest baking temperature is set within a range of 500° C. to 1200° C. According to the method for producing an inorganic product, an inorganic product having a beautiful gloss and a precise decorative portion (image) can be produced.

### BRIEF DESCRIPTION OF THE DRAWINGS

FIG. 1 is a cross-sectional view schematically illustrating a stirring pulverizer used for producing an inkjet ink.

FIG. 2 is an entire view schematically illustrating an example of an inkjet device.

FIG. 3 is a cross-sectional view schematically illustrating an inkjet head of the inkjet device of FIG. 2.

### DETAILED DESCRIPTION OF THE PREFERRED EMBODIMENTS

Preferred embodiments of the present invention will be described below. Note that matters other than matters specifically mentioned in this specification and necessary for the implementation of the present invention can be understood as design matters carried out by those skilled in the art, based on the conventional art in the field. The present invention can be implemented based on the contents disclosed in this specification and the common general technical knowledge in the field.

### 1. Inkjet Ink

An inkjet ink disclosed herein is an inkjet ink for an inorganic base material used for an inorganic base material that is to be baked. The inkjet ink includes at least an inorganic solid portion and a monomer component having a photocurability (photocurable monomer component). Components of the inkjet ink disclosed herein will be described below.

### (1) Inorganic Solid Portion

An inorganic solid portion is a component constituting a base material of a print layer (decorative portion) after baking and includes an inorganic pigment and glass.

### (a) Inorganic Pigment

An inorganic pigment is added in order to develop a desired color in a base material surface after baking. The inorganic pigment can be an inorganic pigment including, for example, a metal compound. The inorganic pigment has excellent heat resistance. Therefore, when baking treatment at 500° C. or more (for example, 500° C. to 1200° C.) is performed on an inorganic base material with an ink deposited thereon, discoloring (or decoloring) of the pigment can be prevented. Specific examples of the inorganic pigment include a composite metal compound mainly containing at least one metallic element selected from a group consisting of Cu, Mn, Zr, Ti, Pr, Cr, Sb, Ni Co, Al, and Cd. In particular, a Zr-based composite metal oxide (for example, ZrSiO₄) mainly containing Zr among these can be preferably used in a viewpoint of heat resistance. For example, in general inkjet printing, inks of three colors, that is, cyan, yellow, and magenta, are combined to draw an image of a desired color. In a case where the above-described Zr-based composite metal oxide is used as an inorganic pigment, an inorganic pigment of each of the above-described three colors can be obtained by doping a predetermined metal element to the Zr-based composite metal oxide. For example, ZrSiO₄—V (vanadium), ZrSiO₄—Pr (praseodymium), and ZrSiO₄—Fe (iron) are respective examples of a Zr-based composite metal material of cyan, Zr-based composite metal material of yellow, and Zr-based composite metal material of magenta, respectively.

Depending on the inkjet device, inks of black and white are used in addition to the above-described three colors in some cases. As an inorganic pigment used for the ink of black, for example, a FeCr-based composite metal compound (for example, spinel black) is preferably used. As an inorganic pigment used for the ink of white, for example, TiO₂, ZrO₂, ZnO, ZrSiO₄, or the like is preferably used.

Note that, as an inorganic pigment in an inkjet ink disclosed herein, an inorganic pigment that can be used for an ink for an inorganic base material can be used without any particular limitation in a range in which effects of the present invention are not impaired, and materials thereof are not limited to the above-described materials.

The inorganic pigment can be typically in a form of particle. It is preferable that a particle diameter of the inorganic pigment in a form of particle is appropriately adjusted in consideration of a diameter of a discharge port of an inkjet device that will be described later. When the particle diameter of the inorganic pigment is too large, the discharge port is likely to clog with the inorganic pigment, so that an ink discharging performance is likely to be reduced. The diameter of the general inkjet device is about 15 μm to 60 μm (for example, 25 μm), and therefore, it is preferable to pulverize the inorganic pigment such that a D₁₀₀ particle diameter (maximum particle diameter) corresponding to cumulative 100 number % from a side at which the particle diameter is smaller is 5 μm or less (preferably 1 μm or less). Note that, as the above-described D₁₀₀ particle diameter, a value measured based on particle size distribution measurement by a dynamic light-scattering method can be employed.

The inorganic pigment may be inorganic particles distributed in a mixed state in glass described later. The inorganic particles can be, for example, nano metal particles. Examples of the nano metal particles include, for example, nano gold particles, nano silver particles, nano copper particles, nano platinum particles, nano titanium particles, nano palladium particles, or the like. The nano metal particles have optical characteristics (for example, a strong photo-absorption band) specific to each of an ultraviolet region to a visible region due to surface plasmon resonance (SPR). For example, nano gold (Au) particles absorb light of a wavelength around 530 nm (green light to light blue light) and presents bluish red (red purple) called “marron.” Therefore, for example, in a case where an ink of red or purple is prepared, as nano metal particles, nano gold particles can be preferably used. As another example, nano silver (Ag) particles absorb light of a wavelength around 420 nm (blue light) and presents yellow. Therefore, for example, in a case where an ink of orange or yellow is prepared, as nano metal particles, nano silver particles can be preferably used.

According to a preferred aspect, a D₅₀ particle diameter of the nano metal particles is 5 nm or more, typically, 100 nm or more, and, for example, 15 nm or more. According to another preferred aspect, a D₅₀ particle diameter of the nano metal particles is approximately 80 nm or less, typically, 50 nm or less, and, for example, 30 nm or less. By setting the D₅₀ particle diameter in the above-described range, an absorbance of a specific wavelength of the nano metal particles is increased, and excellent color presentation can be realized by adding the inorganic particles in a small amount. Moreover, a precise image with little color unevenness can be drawn.

### (b) Glass

Glass melts when baking of the inorganic base material is performed and is solidified by cooling thereafter, and thus, the above-described inorganic pigment is fixed on a surface of the base material. In the inkjet ink disclosed herein, as glass, a material with which the inorganic pigment is coated after cooling and which causes a beautiful gloss to appear is used.

Examples of glass that can have the above-described properties include, for example, SiO₂—B₂O₃ based glass, SiO₂—RO (RO is an oxide of a group 2 element, for example, indicating MgO, CaO, SrO, or BaO. The same applies hereafter) based glass, SiO₂—RO—R₂O (R₂O is an oxide of an alkaline metal element, for example, indicating Li₂O, Na₂O, K₂O, Rb₂O, Cs₂O, or Fr₂O. Specifically, Li₂O. The same applies hereafter) based glass, SiO₂—B₂O₃—R₂O based glass, SiO₂—RO—ZnO based glass, SiO₂—RO—ZrO₂ based glass, SiO₂—RO—Al₂O₃ based glass, SiO₂—RO—Bi₂O₃ based glass, SiO₂—R₂O based glass, SiO₂—ZnO based glass, SiO₂—ZrO₂ based glass, SiO₂-Al₂O₃ based glass, RO—R₂O based glass, RO—ZnO based glass, or the like. Note that these types of glass may contain, in addition to main constituent components that appear in the above-described names, one or two or more components. The glass may be crystallized glass containing crystals as well as general amorphous glass.

In a preferred aspect, when the whole glass is 100 mol %, SiO₂ occupies a half (50 mol %) or more. A ratio of SiO₂ can be approximately 80 mol % or less. In a viewpoint of increasing a melting performance of glass, a component, such as RO, R₂O, B₂O₃, or the like, may be added. In a preferred aspect, when the whole glass is 100 mol %, RO occupies 0 to 35 mol %. In another preferred aspect, when the whole glass is 100 mol %, R₂O occupies 0 to 10 mol %. In still another preferred aspect, when the whole glass is 100 mol %, B₂O₃ occupies 0 to 30 mol %.

Moreover, in a preferred aspect, the glass is constituted by multicomponent glass containing four components or more (for example, five components or more). Thus, a physical stability is increased. For example, a component, such as Al₂O₃, ZnO, CaO, ZrO₂, or the like, may be added, for example, at a ratio of 1 mol % or more. Thus, a chemical durability or a wear resistance of the decorative portion can be increased. In a preferred aspect, when the whole glass is 100 mol %, Al₂O₃ occupies 0 to 10 mol %. In a preferred aspect, when the whole glass is 100 mol %, ZrO₂ occupies 0 to 10 mol %.

A preferred example of the glass disclosed herein is borosilicate glass having the following composition expressed by mol % in terms of oxide:

SiO₂ 40 to 70 mol % (for example, 50 to 60 mol %);

B₂O₃ 10 to 40 mol % (for example, 20 to 30 mol %);

R₂O (at least one of Li₂O, Na₂O, K₂O, and Rb₂O) 3 to 20 mol % (for example, 5 to 10 mol %);

Al₂O₃ 0 to 20 mol % (for example, 5 to 10 mol %);

ZrO₂ 0 to 10 mol % (for example, 3 to 6 mol %);

when the whole glass is 100 mol %. A ratio of SiO₂ to a whole glass matrix of the borosilicate glass described above may be, for example, 40 mol % or more and, typically, 70 mol % or less, for example, 65 mol % or less. A ratio of B₂O₃ to the whole glass matrix may be typically 10 mol % or more, for example, 15 mol % or more, and typically 40 mol % or less, for example, 35 mol % or less. A ratio of R₂O to the whole glass matrix may be typically 3 mol % or more, for example, 6 mol % or more, and typically 20 mol % or less, for example, 15 mol % or less. In a preferred aspect, borosilicate glass contains, as R₂O, Li₂O, Na₂O, and K₂O. A ratio of Li₂O to the whole glass matrix can be, for example, 3 mol % or more and 6 mol % or less. A ratio of K₂O to the whole glass matrix can be, for example, 0.5 mol % or more and 3 mol % or less. A ratio of Na₂O to the whole glass matrix can be, for example, 0.5 mol % or more and 3 mol % or less. A ratio of Al₂O₃ to the whole glass matrix may be typically 3 mol % or more and typically 20 mol % or less, for example, 15 mol % or less. A ratio of ZrO₂ to the whole glass matrix may be typically 1 mol % or more and typically 10 mol % or less, for example, 8 mol % or less.

Furthermore, the borosilicate glass may contain an additional component other than the above-described ones. Examples of the additional component include, for example, BeO, MgO, CaO, SrO, BaO, ZnO, Ag₂O, TiO₂, V₂O₅, FeO, Fe₂O₃, Fe₃O₄, CuO, Cu₂O, Nb₂O₅, P₂O₅, La₂O₃, CeO₂, Bi₂O₃, Pb₂O₃, or the like in a form of oxide. Generally, the borosilicate glass may contain the additional component at a ratio of 10 mol % or less in total when the whole glass is 100 mol %.

Another example of the glass disclosed herein is glass whose 90 mol % or more has the following composition expressed by mol % in terms of oxide:

SiO₂ 45 to 70 mol % (for example, 50 to 60 mol %);

SnO₂ 0.1 to 6 mol % (for example, 1 to 5 mol %);

ZnO 1 to 15 mol % (for example, 4 to 10 mol %);

RO (at least one of BeO, MgO, CaO, SrO, and BaO) 15 to 35 mol % (for example, 20 to 30 mol %);

R₂O (at least one of Li₂O, Na₂O, K₂O, and Rb₂O) 0 to 5 mol % (for example, 1 to 5 mol %);

B₂O₃ 0 to 3 mol % (for example, 0 to 1 mol %);
when the whole glass is 100 mol %.

A ratio of SiO₂ to a whole glass matrix of the glass described above may be, for example, 50 mol % or more, and typically 65 mol % or less, for example, 60 mol % or less. A ratio of SnO₂ to the whole glass matrix may be typically 0.5 mol % or more, for example, 1 mol % or more, and typically 5.5 mol % or less, for example, 5 mol % or less. A ratio of ZnO to the whole glass matrix may be typically 2 mol % or more, for example, 4 mol % or more, and typically 12 mol % or less, for example, 10 mol % or less. A ratio of RO to the whole glass matrix may be typically 18 mol % or more, for example, 20 mol % or more, and typically 32 mol % or less, for example, 30 mol % or less. A ratio of R₂O to the whole glass matrix may be approximately 0.1 mol % or more, for example, 1 mol % or more, and, for example, 3 mol % or less. A ratio of B₂O₃ to the whole glass matrix may be typically 1 mol % or less and, for example, 0.1 mol % or less.

Furthermore, the glass described above may contain an additional component other than the above-described ones. Examples of the additional component include, for example, Ag₂O, Al₂O₃, ZrO₂, TiO₂, V₂O₅, FeO, Fe₂O₃, Fe₃O₄, CuO, Cu₂O, Nb₂O₅, P₂O₅, La₂O₃, CeO₂, Bi₂O₃, or the like in a form of oxide. Generally, the glass may contain the additional component at a ratio of 10 mol % or less in total when the whole glass is 100 mol %.

Note that it is preferable that a linear thermal expansion coefficient (average linear thermal expansion coefficient measured in a temperature region of 25° C. to 500° C. using a thermomechanical analyzer. The same applies hereafter) of the glass is, for example, 4.0×10⁻⁶K⁻¹ to 8.0×10⁻⁶K⁻¹. Thus, a difference in a shrinkage factor from a decoration target (inorganic base material) during baking is reduced, so that separation or cracking is less likely to occur in the decorative portion. There is no particular limitation on a yield point of the glass, but the yield point can be, for example, 400° C. to 700° C. There is no particular limitation on a glass transition point of the glass (Tg value based on differential scanning calorimetry analysis; the same applies hereafter), but the glass transition point can be, for example, 400° C. to 700° C.

The glass can be typically in a form of particle. A particle diameter of the glass in a form of particle affects an ink viscosity, and therefore, it is preferable to appropriately adjust the particle diameter in consideration of a discharging performance of an ink from the inkjet device. Specifically, with the glass having a large particle diameter contained in the ink, the discharge port tends to clog and there is a probability that the discharging performance is reduced. Therefore, it is preferable to control the particle diameter of the glass such that a maximum particle diameter (D₁₀₀ particle diameter corresponding to cumulative 100 number % from a side at which the particle diameter is smaller) of the glass is 1 μm or less (preferably 0.85 μm or less).

### (c) Content of Inorganic Solid Portion

In the inkjet ink disclosed herein, a volume ratio of the inorganic solid portion when a total volume of the inkjet ink is 100 vol % is 30 vol % or less. The “volume of the inorganic solid portion” refers to a total volume of the above-described inorganic pigment and glass. There is a tendency that, as the volume of the inorganic solid portion increases, the ink viscosity increases. Note that, because there are various types of each of the inorganic pigment and the glass contained in the inorganic solid portion and specific gravities thereof vary, in this embodiment, the “volume” of the inorganic solid portion, not a “weight” thereof, is adjusted. As will be described in detail, in the inkjet ink disclosed herein, in order to cause a beautiful gloss to appear after baking, a content of the glass is increased. However, as described above, by causing the volume ratio of the inorganic solid portion to the total volume of the inkjet ink to be 30 vol % or less, the ink viscosity can be maintained at a low level, although the content of the glass is increased. Note that, in a viewpoint of reducing the ink viscosity and thus obtaining a more excellent discharging performance, the volume ratio of the above-described inorganic solid portion is preferably 28 vol % or less, more preferably 25 vol % or less, even more preferably 23 vol % or less, and particularly preferably 20 vol % or less.

Note that, in a viewpoint of achieving both a gloss of an image and a color developing property after baking, a lower limit of the volume ratio of the above-described inorganic solid portion is preferably 1 vol % or more, more preferably 3 vol % or more, even more preferably 5 vol % or more, and particularly preferably 6 vol % or more.

### (d) Content of Glass

As described above, in the inkjet ink disclosed herein, the volume ratio of the grass to the total volume of the inorganic solid portion is increased. Specifically, in the inkjet ink disclosed herein, the volume of the glass when the total volume of the inorganic solid portion is 100 vol % is 78 vol % or more. Thus, an image (decorative portion) that expresses a beautiful gloss after baking can be formed. Note that, in a viewpoint of causing a beautiful gloss to appear, the volume ratio of the glass to the total volume of the inorganic solid portion is preferably 80 vol % or more, more preferably 82 vol % or more, even more preferably 84 vol % or more, and particularly preferably 86 vol % or more. When the volume ratio of the glass is increased too much, the content of the inorganic pigment is insufficient, and therefore, in a viewpoint of ensuring a preferable color developing property after baking, an upper limit of the volume ratio of the glass is preferably 95 vol % or less, more preferably 93 vol % or less, even more preferably 91 vol % or less, and particularly preferably 90 vol % or less.

As described above, in the inkjet ink disclosed herein, the volume ratio of the inorganic solid portion to the total volume of the ink and the volume ratio of the glass to the total volume of the inorganic solid portion are properly adjusted. Thus, both a discharging property during printing and a gloss after baking can be achieved at a high level, and therefore, a beautiful image can be precisely drawn on the inorganic base material.

### (2) Photocurable Monomer Component

The inkjet ink disclosed herein is a photocurable inkjet ink containing a monomer component having a photocurability. The “photocurable monomer component” in this specification is typically liquid, and refers to a material containing at least one type of a resin monomer component that is polymerized (crosslinked) and cured when being irradiated with light (for example, an ultraviolet ray). As the photocurable monomer component, a monomer that can be used for a general photocurable ink can be used without any particular limitation in a range where the effects of the present invention are not remarkably impaired.

Preferred examples of the photocurable monomer component include a photocurable monomer component including (a) a monofunctional acrylate-based monomer, (b) a monofunctional N-vinyl compound monomer, and (c) a multifunctional vinyl ether-based monomer. The photocurable monomer component including monomers of the above-described (a) to (c) has an excellent fixing property (photocurability) to a printing target, and therefore, can be preferably used for various printing targets. The photocurable monomer component including the monomers of the above-described (a) to (c) has also an advantage of an excellent flexibility after photocuring, and therefore, can be particularly preferably used for a printing target (for example, transfer paper for an inorganic base material) that needs to be curved when being used.

### (a) Monofunctional Acrylate-Based Monomer

The monofunctional acrylate-based monomer is a compound containing one acryloyl group (CH₂═CHCOO—) or methacryloyl group (CH₂═CCH₃COO—) in a molecule.

Because the monofunctional acrylate-based monomer is excellent in dispersibility of the inorganic solid portion and an increase in ink viscosity can be suppressed, the monofunctional acrylate-based monomer can contribute to preparation of an ink having a preferable discharging property. The monofunctional acrylate-based monomer has a characteristic of having a relatively low hardness (high flexibility) after photocuring among monomers having a photocurability.

Note that, in a viewpoint of further increasing the discharging property and the flexibility, a volume ratio of the monofunctional acrylate-based monomer when a total volume of the photocurable monomer component is 100 vol % is preferably 40 vol % or more, more preferably 45 vol % or more, even more preferably 50 vol % or more, and particularly preferably 55 vol % or more, for example, 60 vol % or more. On the other hand, the monofunctional acrylate-based monomer tends to have a relatively low photocurability, and therefore, in a viewpoint of ensuring a content of a monomer excellent in photocurability, which will be described later, the volume ratio of the monofunctional acrylate-based monomer is preferably 96 vol % or less, more preferably 90 vol % or less, even more preferably 85 vol % or less, and particularly preferably 80 vol % or less, for example, 78 vol % or less.

Specific examples of the monofunctional acrylate-based monomer include, for example, benzyl acrylate, cyclic trimethylolpropane formal acrylate, phenoxyethyl acrylate, iso-bornyl acrylate, tetrahydrofurfuryl acrylate, methoxyethyl acylate, cyclohexyl acrylate, ethylcarbitol acrylate, (2-methyl-2-ethyl-1, 3-dioxolane-4-yl)methyl acrylate, hydroxyethyl acrylate, hydroxypropyl acrylate, 4-hydroxybutyl acrylate, methyl (meth)acrylate, ethylacrylate, propyl acrylate, butyl acrylate, pentyl acrylate, n-stearylacrylate, butoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxybutyl (meth)acrylate, 2-hydroxy-3-phenoxypropyl (meth)acrylate, t-butylcyclohexyl (meth)acrylate, isoamyl acrylate, lauryl (meth)acrylate, octyl acrylate, isooctyl (meth)acrylate, isononyl acrylate, decyl acrylate, isodecyl acrylate, tridecyl (meth)acrylate, isomyristyl acrylate, isostearyl acrylate, 2-ethylhexyl acrylate, 2-ethylhexyl-diglycol acrylate, 4-hydroxybutyl acrylate, methoxy diethylene glycol acrylate, methoxy triethylene glycol acrylate, ethoxy diethylene glycol acrylate, 2-(2-etoxyetoxy)ethyl acrylate, 2-ethylhexyl carbitol acrylate, phenoxy ethoxyethyl acrylate, or the like. One type of the above-described (meth)acrylate compounds can be used alone or two or more types of the above-described (meth)acrylate compounds can be used in combination. Among these, benzyl acrylate, phenoxyethyl acrylate, and cyclic trimethylolpropane formal acrylate are particularly excellent in flexibility after photocuring, and therefore, generation of a crack when transfer paper is curved can be preferably prevented.

### (b) Monofunctional N-Vinyl Compound Monomer

A monofunctional N-vinyl compound monomer is a compound in which one vinyl group is bonded to a nitrogen (N) atom of a nitrogen-containing compound. As used herein, the “vinyl group” refers to CH₂═CR¹— (herein, R¹ is a hydrogen atom or an organic group). The monofunctional N-vinyl compound monomer has a high drawability, and therefore, generation of a crack in a drawn image can be suppressed. The monofunctional N-vinyl compound monomer has an excellent photocurability and has a function of increasing the fixing property to a surface of a printing target.

Note that, in a viewpoint of further increasing the fixing property, a volume ratio of the monofunctional N-vinyl compound monomer when the total volume of the photocurable monomer component is 100 vol % is preferably 2 vol % or more, more preferably 3 vol % or more, even more preferably 4 vol % or more, and particularly preferably 5 vol % or more. On the other hand, there is a tendency that, when the monofunctional N-vinyl compound monomer is added, the flexibility of the ink after curing is reduced. Therefore, in a case where the transfer paper for an inorganic base material is a printing target, a content of the monofunctional N-vinyl compound monomer is preferably small. In view of the foregoing, the volume ratio of the monofunctional N-vinyl compound monomer is preferably 20 vol % or less, more preferably 17 vol % or less, even more preferably 15 vol % or less, and particularly preferably 13 vol % or less, for example, 10 vol % or less.

The N-vinyl compound monomer is represented, for example, by the following general formula (1).

CH₂═CR¹—NR²R³ [Formula 1]

In the general formula (1) above, le is a hydrogen atom, an alkyl group of carbon atom number 1 to 4, a phenyl group, a benzyl group, or a halogen group. Among them, the hydrogen atom and the alkyl group of carbon atom number 1 to 4 are preferable, and the hydrogen atom is particularly preferable. Each of R² and R³ can be a group selected from a group consisting of a hydrogen atom, an alkyl group, an alkenyl group, an alkynyl group, an aralkyl group, an alkoxy group, an alkoxy alkyl group, an alkylol group, and an acetyl group (CH₃CO—) each of which may have a substituent, and an aromatic group. Note that R² and R³ may be the same and may be different from each other. A total number of carbon atoms in the alkyl group, the alkenyl group, the alkynyl group, the aralkyl group, the alkoxy group, the alkoxy alkyl group, the alkylol group, and the acetyl group each of which may have a substituent can be 1 to 20. The alkyl group, the alkenyl group, the alkynyl group, the aralkyl group, the alkoxy group, the alkoxy alkyl group, the alkylol group, and the acetyl group can be chain groups or cyclic groups, and are preferably chain groups. The aromatic group may be an aryl group which may have a substituent. A total number of carbon atoms in the aromatic group is 6 to 36. Examples of the substituent that each of the alkyl group, the alkenyl group, the alkynyl group, the aralkyl group, the alkoxy group, the alkoxy alkyl group, the alkylol group, the acetyl group, and the aromatic group can possibly have include, for example, a hydroxyl group and a halogen atom, such as, a fluorine atom, a chlorine atom, or the like. In the general formula (1) above, le and R³ may be bonded to each other to form a cyclic structure.

Preferred examples of the monofunctional N-vinyl compound monomer include N-vinyl-2-caprolactam, N-vinyl-2-pyrolidone, N-ninyl-3-morpholinone, N-vinyl piperidine, N-vinyl pyrrolidine, N-vinyl aziridine, N-vinyl azetidine, N-vinyl imidazole, N-vinyl morpholine, N-vinyl pyrazole, N-vinyl valerolactam, N-vinyl carbazole, N-vinyl phthalimide, N-vinyl formamide, N-vinyl acetamide, N-methyl-N-vinyl formamide, N-methyl-N-vinyl acetamide, or the like. Among them, N-vinyl-2-caprolactam has high phorocurability among monofunctional N-vinyl compound monomers, and can preferably increase the fixing property to a surface of a printing target.

### (c) Multifunctional Vinyl Ether-Based Monomer

A multifunctional vinyl ether-based monomer is a compound containing at least two vinyl ether groups in a molecule. As used herein, the “vinyl ether group” refers to —O—CH═CHR¹ (where R¹ is a hydrogen atom or an organic group). The multifunctional vinyl ether-based monomer containing at least two vinyl ether groups has a high photocuring rate when being irradiated with an UV ray and has an excellent photocurability, and therefore, has a function of increasing a fixing property to a surface of a printing target. Furthermore, the multifunctional vinyl ether-based monomer has a low hardness after photocuring among monomers having an excellent photocurability and has an excellent flexibility.

Note that, in a viewpoint of achieving both the fixing property to a printing target and the flexibility after photocuring, a volume ratio of the multifunctional vinyl ether-based monomer when the total volume of the monomer component is 100 vol % is preferably 2 vol % or more, more preferably 5 vol % or more, even more preferably 7 vol % or more, and particularly preferably 10 vol % or more, for example, 15 vol % or more. On the other hand, there is a tendency that, when the multifunctional vinyl ether-based monomer is added too much, an addition amount of the monofunctional acrylate-based monomer is reduced and the flexibility after photocuring is reduced. Therefore, an upper limit of the volume ratio of the multifunctional vinyl ether-based monomer is preferably 40 vol % or less, more preferably 35 vol % or less, even more preferably 30 vol % or less, and particularly preferably 25 vol % or less, for example, 20 vol % or less.

Preferred examples of the multifunctional vinyl ether-based monomer include ethylene glycol divinyl ether, diethylene glycol divinyl ether, triethylene glycol divinyl ether, tetraethylene glycol divinyl ether, polyethylene glycol divinyl ether, propylene glycol divinyl ether, dipropylene glycol divinyl ether, tripropylene glycol divinyl ether, polypropylene glycol divinyl ether, butanediol divinyl ether, neopentyl glycol divinyl ether, hexanediol divinyl ether, nonanediol divinyl ether, 1,4-cyclohexane dimethanol divinyl ether, or the like. Among these, diethylene glycol divinyl ether, triethylene glycol divinyl ether, and 1,4-cyclohexane dimethanol divinyl ether can achieve both the fixing property to a base material surface and the flexibility after photocuring at a high level, and therefore, are particularly preferable.

Note that, in a case where the photocurable monomer component containing the monomers of (a) to (c) described above is used, a volume ratio of the monomer component when the total volume of the inkjet ink is 100 vol % is preferably 44 vol % or more, more preferably 45 vol % or more, even more preferably 50 vol % or more, and particularly preferably 55 vol % or more. Thus, the fixing property to a surface of a printing target and the flexibility after fixing can be achieved at a higher level. Moreover, in a viewpoint of sufficiently ensuring a content of the inorganic solid portion and forming an image (decorative portion) excellent in gloss and color developing performance, the volume ratio of the monomer component is preferably 85 vol % or less, more preferably 80 vol % or less, even more preferably 75 vol % or less, and particularly preferably 70 vol % or less.

### (d) Other Monomers

Note that, as described above, as the photocurable monomer component in the inkjet ink disclosed herein, a monomer component that can be used for a general photocurable inkjet ink can be used without any particular limitation, and the photocurable monomer component is not limited to the monomers of (a) to (c) described above.

One example of other monomers than (a) to (c) described above is a multifunctional acrylate-based monomer containing at least two acryloyl groups or methacryloyl groups in a molecule. Preferred examples of the multifunctional acrylate-based monomer include 1,9-nonanediol di(meth)acrylate, 1,6-hexanediol di(meth)acrylate, 1,4-butanediol di(meth)acrylate, tricyclodecane dimethanol diacrylate, hydroxy pivalic acid neopently glycol diacrylate, triethylene glycol di(meth)acrylate, tetramethylene glycol di(meth)acrylate, tripropylene glycol di(meth)acrylate, polypropylene glycol di(meth)acrylate, 1,3-butanediol di(meth)acrylate, neopentyl glycol di(meth)acrylate, hexanediol di(meth)acrylate, cyclohexane-1,4-dimethanol di(meth)acrylate, cyclohexane-1,3-dimethanol di(meth)acrylate, 1,4-cyclohexane diol di(meth)acrylate, tetraethylene glycol di(meth)acrylate, pentaerythritol di(meth)acrylate, dipentaerythritol di(meth)acrylate, neopentyl glycol di(meth)acrylate, polytetramethylene glycol di(meth)acrylate, bisphenol AEO 3.8 molar adduct diacrylate, trimethylolpropane tri(meth)acrylate, trimethylolethane tri(meth)acrylate, trimethyloloctane tri(meth)acrylate, pentaerythritol tri(meth)acrylate, trimethylolpropane polyethoxy tri(meth)acrylate, dipentaerythritol tri(meth)acrylate, propionic acid dipentaerythritol tri(meth)acrylate, tris-(2-hydroxyethyl)isocyanurate tri(meth)acrylate, sorbitol tri(meth)acrylate, ditrimethylol propane tetra(meth)acrylate, pentaerythritol polyethoxy tetra(meth)acrylate, pentaerythritol polypropoxy tetra(meth)acrylate, sorbitol tetra(meth)acrylate, propionic acid dipentaerythritol tetra(meth)acrylate, ethoxylated pentaerythritol tetra(meth)acrylate, sorbitol penta(meth)acrylate, dipentaerythritol penta(meth)acrylate, dipentaerythritol hexa(meth)acrylate, sorbitol hexa(meth)acrylate, or the like.

Examples of other monomers than the multifunctional acrylate-based monomer include butyl vinyl ether, butyl propenyl ether, butyl butenyl ether, hexyl vinyl ether, ethylhexyl vinyl ether, phenyl vinyl ether, benzyl vinyl ether, phenyl allyl ether, vinyl acetate, acrylamide, methacrylamide, trimethylol propane tri((meth)acryloyloxypropyl) ether, tri((meth)acryloyloxyethyl) isocyanurate, bisphenol A diglycidyl ether acrylic acid adduct, or the like.

Note that it is not intended to limit the technology disclosed herein, but in a viewpoint of achieving an ink in which a phorocurability and a flexibility have been achieved at a high level, it is preferable that the photocurable monomer component does not substantially contain the above-described other monomers and the photocurable monomer component containing only the above-described monomers of (a) to (c) is used. Note that “the photocurable monomer component does not substantially contain the other monomers” in the foregoing means that the other monomers are not intentionally added to the photocurable monomer component. Therefore, a case where a tiny amount of a component that can be considered as the other monomers is inevitably contained due to a raw material, a manufacturing process, or the like is included in a concept that “the photocurable monomer component does not substantially contain the other monomers” in this specification. For example, in a case where a volume ratio of the other monomers is 1 vol % or less (preferably 0.1 vol % or less, more preferably 0.01 vol % or less, even more preferably 0.001 vol % or less, and particularly preferably 0.0001 vol % or less), “the photocurable monomer component does not substantially contain the other monomers and is constituted only by the monomers of (a) to (c) described above.”

### (3) Other Components

The inkjet ink disclosed herein may further contain a known additive (for example, a dispersant, a photopolymerization initiator, a polymerization inhibitor, a binder, a viscosity modifier, or the like) that can be used for an inkjet ink (typically, an inkjet ink for an inorganic base material and a photocurable inkjet ink) as necessary in a range where the effects of the present invention are not impaired. Note that a content of the additive may be appropriately set in accordance with a purpose of adding and does not characterize the present invention, and therefore, detailed description thereof will be omitted.

### (a) Dispersant

The inkjet ink disclosed herein may contain a dispersant. As the dispersant, for example, a cationic dispersant is used. The cationic dispersant efficiently adheres to a surface of the inorganic pigment due to an acid-base reaction, and therefore, unlike other dispersants, such as a phosphoric acid dispersant or the like, agglomeration of the inorganic pigment can be suppressed and the inorganic pigment can be preferably dispersed. One example of the cationic dispersant is an amine-based dispersant. The amine-based dispersant can prevent agglomerating of the inorganic pigment due to a steric barrier and also can stabilize the inorganic pigment. Moreover, the amine-based dispersant can give the same charges to particles of the inorganic pigment, and therefore, also in this point, can preferably prevent agglomerating of the inorganic pigment. Therefore, the viscosity of the ink can be preferably reduced to largely increase printability. Examples of the amine-based dispersant include a fatty acid amine-based dispersant, a polyester amine-based dispersant, or the like, and, for example, DISPERBYK-2013 manufactured by BYK Japan KK or the like can be preferably used.

### (b) Photopolymerization Initiator

The inkjet ink disclosed herein may contain a photopolymerization initiator. As the photopolymerization initiator, a photopolymerization initiator conventionally used can be appropriately selected. One example of the photopolymerization initiator is, for example, a radical photopolymerization initiator, such as an alkylphenone-based photopolymerization initiator, an acylphosphine oxide-based photopolymerization initiator, or the like. As the alkylphenone-based photopolymerization initiator, for example, an α-aminoalkylphenon-based photopolymerization initiator (for example, 2-methyl-1-(4-methylthiophenyl)-2-morpholinopropane-1-on, 2-benzyl-2-dimethylamino-1-(4-morpholinophenyl)-butanone-1, 2-(dimethylamino)-2-[(4-methylpheny)methyl]-1-[4-(4-morpholiny)phenyl]-1-butanone, or the like) can be preferably used. As another example of the alkylphenone-based photopolymerization initiator, an α-hydroxyalkylphenone-based photopolymerization initiator (1-hydroxy-cyclohexyl-phenyl-ketone, 2-hydroxy-2-methyl-1-phenyl-propane-1-on, 1-[4-(2-hydroxyethoxy)-phenyl]-2-hydroxy-2-methyl-1-propane-1-on, 2-hydroxy-1-{4-[4-(2-hydroxy-2-methyl-propionyl)-benzyl]phenyl}-2-methyl-propane-1-on, or the like) can be used.

Among the various photopolymerization initiators described above, the α-aminoalkylphenon-based photopolymerization initiator, such as 2-methyl-1-(4-methylthiophenyl)-2-morpholinopropane-1-on or the like can exhibit a high reactivity to increase a curing rate of the ink, has excellent thin film curing property and surface curing property, and therefore, can be particularly used.

### (c) Polymerization Inhibitor

The inkjet ink disclosed herein may contain a polymerization inhibitor. By adding the polymerization inhibitor, polymerization and curing of the photocurable monomer component can be suppressed before being used, and therefore, storage of the ink can be facilitated. As the polymerization inhibitor, a polymerization inhibitor conventionally used in the field of photocurable inkjet ink can be used without any particular limitation in a range in which the photocurability of the photocurable monomer component containing the monomers of (a) to (c) described above are not markedly impaired, and the inorganic pigments are not limited to the above-described materials. Examples of the polymerization inhibitor include, for example, hydroquinone, methoquinone, di-t-butylhydroquione, P-methoxyphenol, butylhydroxytoluene, nitrosoamine salt, or the like. Among compounds included the foregoing, N-nitrophenyl hydroxylamine aluminum salt has an excellent long-term storage stability and is particularly preferable.

### 2. Preparation of Inkjet Ink

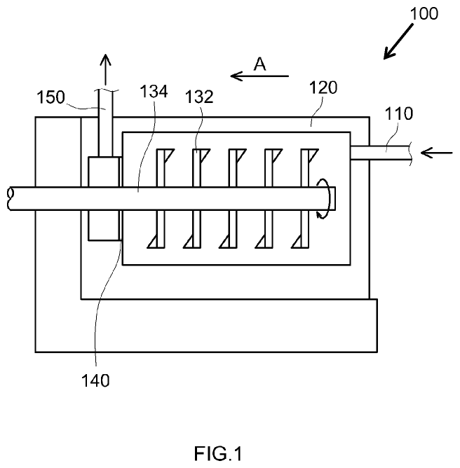

Next, procedures of preparing (producing) the inkjet ink disclosed herein will be described. The inkjet ink disclosed herein can be prepared by cracking and dispersing the inorganic solid portion after mixing the above-described raw materials in a predetermined ratio. FIG. 1 is a cross-sectional view schematically illustrating a stirring pulverizer used for producing an inkjet ink. Note that, in the following description, it is not intended to limit the inkjet ink disclosed herein.

When producing the inkjet ink disclosed herein, first, the above-described raw materials are weighted and mixed to prepare a slurry that is a precursor of the ink.

Next, using a stirring pulverizer 100 illustrated in FIG. 1, stirring of the slurry and pulverization of the inorganic solid portion (the inorganic pigment and the glass) are performed. Specifically, after adding beads (for example, zirconia bards having a diameter of 0.5 mm) for pulverization to the above-described slurry, the slurry is supplied to a stirring vessel 120 through a supply port 110. A shaft 134 having a plurality of stirring blades 132 is housed in the stirring vessel 120. One end of the shaft 134 is attached to a motor (not illustrated), the motor is operated to cause the shaft 134 to rotate, and thus, the slurry is stirred by the plurality of stirring blades 132 while the slurry is sent out to a downstream side of a liquid feeding direction A. While stirring the slurry, the inorganic solid portion is pulverized by the beads for pulverization added to the slurry and the atomized inorganic solid portion is dispersed in the slurry.

Then, the slurry sent to the downstream side in the liquid feeding direction A passes through a filter 140. Thus, the beads for pulverization and a part of the inorganic solid portion that has not been atomized are collected by the filter 140 and the inkjet ink in which the atomized inorganic solid portion is sufficiently dispersed is exhausted from an exhaust port 150. By adjusting a hole diameter of the filter 140 at this time, a maximum particle diameter of the inorganic solid portion in the inkjet ink can be controlled.

### 3. Application of Inkjet Ink

Next, application of the inkjet ink disclosed herein will be described. As described above, the inkjet ink disclosed herein is used for an inorganic base material that is to be baked. In this specification, “being used for an inorganic base material” is a concept including not only a mode in which the ink is deposited directly on a surface of an inorganic base material but also a mode in which the ink is deposited indirectly on the surface of the inorganic base material via transfer paper or the like. That is, the inkjet ink disclosed herein can be used for printing on transfer paper for an inorganic base material (producing transfer paper) or printing on a surface of an inorganic base material (producing the inorganic base material).

### (1) Production of Transfer Paper

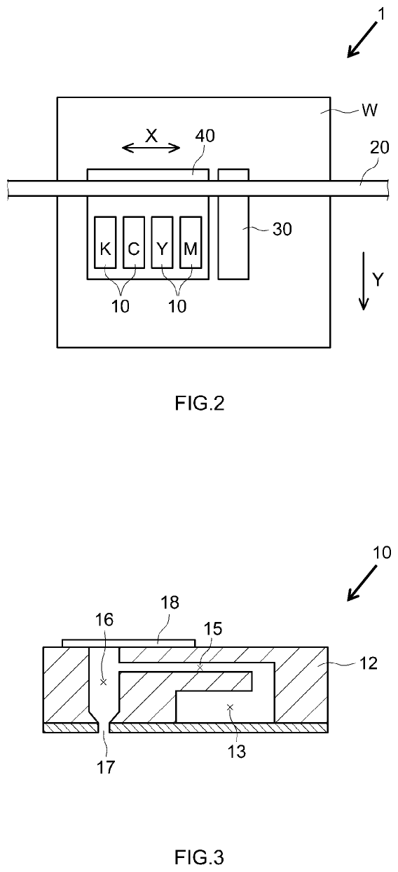

Using the inkjet ink disclosed herein, a method for producing transfer paper for an inorganic base material (a printing method for drawing an image on a surface of transfer paper) will be described. FIG. 2 is an entire view schematically illustrating an example of an inkjet device. FIG. 3 is a cross-sectional view schematically illustrating an inkjet head of the inkjet device of FIG. 2.

The inkjet ink disclosed herein is stored in an inkjet head 10 of an inkjet device 1 illustrated in FIG. 2. The inkjet device 1 includes four inkjet heads 10 and inks of four different colors, that is, black (K), cyan (C), yellow (Y), and magenta (M), are stored in the inkjet heads 10, respectively. The inkjet heads 10 are housed in a printing cartridge 40. The printing cartridge 40 is inserted in a guide shaft 20 and configured to reciprocate along an axial direction X of the guide shaft 20. Although not illustrated, the inkjet device 1 includes a moving device that moves the guide shaft 20 in a perpendicular direction Y to the guide shaft 20. Thus, the ink can be discharged from the inkjet heads 10 to a predetermined position of a mount W of transfer paper.

A piezo-type inkjet head illustrated in FIG. 3 is used for the inkjet heads 10 illustrated in FIG. 2. Each of the piezo-type inkjet heads 10 is provided with a storage section 13 that stores the ink in a case 12, and the storage section 13 communicates with a discharge section 16 via a liquid feeding path 15. In the discharge section 16, a discharge port 17 opened to the outside of the case 12 is provided and a piezo element 18 is arranged so as to be opposed to the discharge port 17. In the inkjet head 10, by causing the piezo element 18 to vibrate, the ink in the discharge section 16 is discharged to the mount W (see FIG. 2) from the discharge port 17.

An UV irradiation device 30 is attached to the guide shaft 20 of the inkjet device 1 illustrated in FIG. 2. The UV irradiation device 30 is arranged adjacent to the printing cartridge 40, moves in accordance with reciprocating movement of the printing cartridge 40, and irradiates the mount W with the ink deposited thereon with an ultraviolet ray. Thus, the ink is cured immediately after the ink is deposited on a surface of the mount W, and therefore, the ink in a sufficient thickness can be fixed on the surface of transfer paper (mount W).

As described above, in the inkjet ink disclosed herein, a volume of the inorganic solid portion to the total volume of the inkjet ink is adjusted to be 30 vol % or less. Thus, the ink viscosity can be maintained low, and therefore, the ink can be discharged from the discharge port 17 at high accuracy to allow drawing a precise image on a surface of a printing target (transfer paper in this case).

It is preferable to use the photocurable monomer component containing the monomers of (a) to (c) described above for producing the above-described transfer paper. Thus, an image (cured ink) having sufficient flexibility can be drawn, and therefore, generation of a crack in the image when the transfer paper is curved can be preferably prevented.

### (2) Production Method for Inorganic Product

Next, using the inkjet ink disclosed herein, a method for producing an inorganic product. The production method includes depositing the inkjet ink disclosed herein on a surface of an inorganic base material and baking the inorganic base material.

There is no particular limitation on a raw material of the inorganic base material used in the method of producing an in organic product, a raw material that can be used as a general raw material for an inorganic base material can be used without any particular limitation. As one example of the inorganic base material, an inorganic base material, such as a ceramic base material, that is, for example, a ceramic, a ceramic tile, or the like, a glass base material, a metal base material, or the like, that is to be baked can be used.

In the production method disclosed herein, first, the inkjet ink is deposited on a surface of an inorganic base material. There is no particular limitation on a device used for depositing the ink on the inorganic base material. The ink may be deposited directly on the surface of the inorganic base material using an inkjet device and the ink may be deposited indirectly on the surface of the inorganic base material via the above-described transfer paper. Note that, in a case where the ink is directly deposited using the inkjet device, it is preferably to discharge the ink to the surface of the inorganic base material in accordance with the same procedures as those of the above-described “producing transfer paper.”

In the production method disclosed herein, next, the inorganic base material with the ink deposited thereon is baked under a condition where a highest baking temperature is set in a range of 500° C. to 1200° C. (preferably, 500° C. to 1000° C., more preferably 600° C. to 900° C.). Thus, a resin component into which monomers have been cured is burned and the glass in the inorganic solid portion melts. Then, by cooling the inorganic base material after baking, the molten glass is solidified and the inorganic pigment is fixed to a base material surface. At this time, in the inkjet ink disclosed herein, the volume of the glass to the total volume of the inorganic solid portion is adjusted to be 78 vol % or more, and therefore, the inorganic pigment is coated with a sufficient amount of the glass. Thus, a beautiful gloss can be caused to appear in the decorative portion (image) after baking.

### Test Examples

Test examples related to the present invention will be described below, but it is not intended to limit the present invention to the test examples.

### <Inkjet Ink>

Twenty-four inkjet inks (Example 1 to 24) containing the inorganic solid portion and the photocurable monomer were prepared. Specifically, slurries were prepared by mixing raw materials at volume ratios indicated by Tables 1 to 3 and cracking and dispersing processing was preformed using the beads (zirconia bards having a diameter of 0.5 mm) for pulverization, thereby obtaining inks of Examples 1 to 25. Note that the volume ratios in the tables are values in a case where a total volume of each of the inks is 100 vol %, unless otherwise noted in the tables. In the test examples, in addition to the inorganic solid portion and the photocurable monomer, a dispersant (DISPERBYK-2013 manufactured by BYK Japan KK), a photopolymerization initiator (Omnirad 819 manufactured by IGM RESINS), and a polymerization inhibitor (Q-1301 (N-nitroso-N-phenylhydroxylamine aluminum) manufactured by FUJIFILM Wako Pure Chemical Corporation) were added. Volume ratios of the dispersant, the initiator, and the inhibitor are also indicated in Tables 1 to 3.

Note that, for the inorganic solid portion used in the test examples, “yellow” in Tables 1 to 3 is a zircon-based yellow inorganic pigment (zircon praseodymium). “Cyan” is a zircon-based cyan inorganic pigment (zircon vanadium). “Black” is a spinel-based black inorganic pigment (spinel black). The “glass” is borosilicate glass whose softening point is 550° C.

The “photocuring component” in Tables 1 to 3 is a component obtained by mixing the monofunctional acrylate-based monomer of iso-bornyl acrylate (manufactured by Osaka Organic Chemical Industry LTD.), benzyl acrylate (manufactured by Osaka Organic Chemical Industry LTD.), phenoxyethyl acrylate (manufactured by Osaka Organic Chemical Industry LTD.), cyclic trimethylolpropane formal acrylate (manufactured by Osaka Organic Chemical Industry LTD.); the monofunctional N-vinyl compound monomer of N-vinyl caprolactam (manufactured by Tokyo Chemical Industry Co., Ltd.); the multifunctional vinyl ether-based monomer of triethylene glycol divinyl ether (manufactured by Nippon Carbide Industries Co., Inc.), diethylene glycol divinyl ether (manufactured by Nippon Carbide Industries Co., Inc.), triethylene glycol divinyl ether, and 1,4-cyclohexane dimethanol divinyl ether (manufactured by Nippon Carbide Industries Co., Inc.); and the multifunctional acrylate-based monomer of 1,9-nonanediol acrylate (manufactured by Osaka Organic Chemical Industry LTD.) at a predetermined volume ratio.

### <Evaluation Test>

### (1) Evaluation of Ink Viscosity

An ink viscosity of each of the examples prepared was measured using a B-type viscometer. Note that ink temperature at measurement was set to 25° C. and a rotation speed of a spindle was set to 5 rpm. A reference viscosity with which the ink could be preferably discharged from the inkjet device was set to be lower than 70 mPa·s, the samples that satisfied the reference viscosity were evaluated “pass” and the samples that did not satisfy the reference viscosity were evaluated “fail.” Evaluation results are indicated in Tables 1 to 3.

### (2) Evaluation of Gloss

The ink of each of the samples described above was irradiated with an UV ray while being discharged to a surface of a mount (manufactured by Marushige Shiko Co., Ltd.) using the inkjet device (MATERIAL PRINTER (DMP-2831) manufactured by FUJIFILM Corporation), thereby producing transfer paper for an inorganic base material on which a coating film (image) having a thickness of 50 to 100 μm was formed. The transfer paper for an inorganic base material was bonded to a surface of a ceramic ware containing, as a main component, bone ash, kaoline, feldspar, or the like, and was baked at 850° C., thereby producing a ceramic ware (inorganic product) having a decorative portion.

Next, an 8° gloss value of the decorative portion (ink after baking) of the ceramic ware after baking was measured using a spectral colorimeter (Konica Minolta, Inc., Model: CM-600). In a case where the measured gloss value was 75 or more, the gloss value was evaluated “good,” in a case where the measured gloss value was 60 or more and less than 75, the gloss value was evaluated “pass,” and in a case where the measured gloss value was less than 60, the gloss value was evaluated “fail”. Evaluation results are indicated in Tables 1 to 3.

TABLE 1

| Compo- | Name of Raw | | Example | Example | Example | Example | Example | Example | Example | Example | Example | Example |
|---|---|---|---|---|---|---|---|---|---|---|---|---|
| sition | Material | | 1 | 2 | 3 | 4 | 5 | 6 | 7 | 8 | 9 | 10 |
| (vol %) | Inorganic | Yellow | — | — | — | — | 2.3 | — | — | — | — | 2.6 |
| | Pigment | Cyan | — | — | — | 1.8 | — | — | — | — | 2.6 | — |
| | | Black | 0.7 | 0.9 | 1.5 | — | — | 1.8 | 2.3 | 2.2 | — | — |

| | Glass | 5.3 | 7.4 | 12.3 | 14.0 | 13.7 | 14.5 | 15.7 | 17.7 | 17.6 | 17.6 |
|---|---|---|---|---|---|---|---|---|---|---|---|
| | Dispersant | 5.5 | 7.6 | 19.3 | 14.1 | 14.7 | 15.0 | 16.9 | 18.3 | 18.3 | 18.3 |
| | Photocurable | 85.0 | 80.7 | 59.5 | 68.3 | 67.4 | 66.0 | 62.9 | 59.3 | 59.1 | 59.1 |
| | Component | | | | | | | | | | |
| | Polymerization | 3.1 | 3.0 | 7.4 | 1.7 | 1.7 | 2.4 | 2.0 | 2.2 | 2.1 | 2.1 |
| | Initiator | | | | | | | | | | |
| | Polymerization | 0.4 | 0.5 | — | 0.2 | 0.2 | 0.3 | 0.2 | 0.3 | 0.3 | 0.3 |
| | Inhibitor | | | | | | | | | | |
| | Total | 100.0 | 100.0 | 100.0 | 100.0 | 100.0 | 100.0 | 100.0 | 100.0 | 100.0 | 100.0 |
| Volume Ratio of | | 6.0 | 8.3 | 13.7 | 15.8 | 16.0 | 16.3 | 18.0 | 19.9 | 20.2 | 20.2 |
| Inorganic Solid Portion) | | | | | | | | | | | |
| (vs Total Volume of Ink) | | | | | | | | | | | |
| Volume Ratio of Glass | | 89.0 | 89.0 | 89.4 | 88.7 | 85.4 | 88.9 | 87.2 | 88.8 | 87.1 | 87.1 |
| (vs Total Volume of | | | | | | | | | | | |
| Inorganic Solid Portion) | | | | | | | | | | | |
| Evalu- | Ink Viscosity | Good | Good | Good | Good | Good | Good | Good | Good | Good | Good |
| ation | Gloss | Good | Good | Good | Good | Good | Good | Good | Good | Good | Good |
| | Total Evaluation | Good | Good | Good | Good | Good | Good | Good | Good | Good | Good |

TABLE 2

| Compo- | Name of Raw | | Example | Example | Example | Example | Example | Example | Example | Example | Example | Example |
|---|---|---|---|---|---|---|---|---|---|---|---|---|
| sition | Material | | 11 | 12 | 13 | 14 | 15 | 16 | 17 | 18 | 19 | 20 |
| (vol %) | Inorganic | Yellow | — | — | — | 3.9 | — | — | — | 4.5 | — | — |
| | Pigment | Cyan | — | — | — | — | — | 3.3 | — | — | 4.3 | — |
| | | Black | 2.5 | 3.0 | 2.7 | — | 2.9 | — | 2.1 | — | — | 3.9 |

| | Glass | 19.7 | 23.6 | 24.8 | 15.4 | 16.4 | 16.3 | 5.7 | 14.3 | 14.7 | 31.3 |
|---|---|---|---|---|---|---|---|---|---|---|---|
| | Dispersant | 20.4 | 24.4 | 24.9 | 18.5 | 18.5 | 18.4 | 18.9 | 18.6 | 18.5 | 32.3 |
| | Photocurable | 54.7 | 47.1 | 44.3 | 59.8 | 59.8 | 59.5 | 69.0 | 60.1 | 60.0 | 31.2 |
| | Component | | | | | | | | | | |
| | Polymerization | 2.4 | 1.7 | 2.9 | 2.2 | 2.2 | 2.2 | 4.3 | 2.2 | 2.2 | 1.1 |
| | Initiator | | | | | | | | | | |
| | Polymerization | 0.3 | 0.2 | 0.4 | 0.3 | 0.3 | 0.3 | — | 0.3 | 0.3 | 0.2 |
| | Inhibitor | | | | | | | | | | |
| | Total | 100.0 | 100.0 | 100.0 | 100.0 | 100.0 | 100.0 | 100.0 | 100.0 | 100.0 | 100.0 |
| Volume Ratio of | | 22.2 | 26.6 | 27.5 | 19.3 | 19.3 | 19.7 | 7.8 | 18.8 | 19.0 | 35.2 |
| Inorganic Solid Portion) | | | | | | | | | | | |
| (vs Total Volume of Ink) | | | | | | | | | | | |
| Volume Ratio of Glass | | 88.8 | 88.9 | 90.2 | 79.9 | 85.2 | 83.0 | 73.4 | 76.0 | 77.5 | 88.9 |
| (vs Total Volume of | | | | | | | | | | | |
| Inorganic Solid Portion) | | | | | | | | | | | |
| Evalu- | Ink Viscosity | Good | Good | Good | Good | Good | Good | Good | Good | Good | Fail |
| ation | Gloss | Good | Good | Good | Pass | Pass | Pass | Fail | Fail | Fail | Good |
| | Total Evaluation | Good | Good | Good | Pass | Pass | Pass | Fail | Fail | Fail | Fail |

TABLE 3

| Composition | Name of Raw | | Example | Example | Example | Example |
|---|---|---|---|---|---|---|
| (vol %) | Material | | 21 | 22 | 23 | 24 |
| | Inorganic | Yellow | — | 5.0 | — | 5.5 |
| | Pigment | Cyan | — | — | — | — |
| | | Black | 3.3 | — | 5.5 | — |

| | Glass | 26.7 | 28.1 | 28.6 | 29.1 |
|---|---|---|---|---|---|
| | Dispersant | 16.5 | 18.2 | 19.0 | 16.5 |
| | Photocurable | 51.7 | 47.0 | 45.2 | 47.1 |
| | Component | | | | |
| | Polymerization | 1.7 | 1.5 | 1.5 | 1.7 |
| | Initiator | | | | |
| | Polymerization | 0.1 | 0.2 | 0.2 | 0.1 |
| | Inhibitor | | | | |
| | Total | 100.0 | 100.0 | 100.0 | 100.0 |
| Volume Ratio of | | 30.0 | 33.1 | 34.1 | 34.6 |
| Inorganic Solid Portion) | | | | | |
| (vs Total Volume of Ink) | | | | | |
| Volume Ratio of Glass | | 89.0 | 84.9 | 83.9 | 84.1 |
| (vs Total Volume of | | | | | |
| Inorganic Solid Portion) | | | | | |
| Evaluation | Ink Viscosity | Good | Good | Good | Fail |
| | Gloss | Good | Good | Pass | pass |
| | Total Evaluation | Good | Good | Pass | Fail |

As illustrated in Tables 1 to 3, Examples 1 to 16 and Examples 21 to 23 were evaluated “pass” or higher for both the ink viscosity before curing and the gloss after baking. Based on this, it was confirmed that both the ink viscosity and the gloss after baking can be achieved at a high level by making the volume of the inorganic solid portion to the total volume of the ink 30 vol % or less and the volume of the glass to the total volume of the inorganic solid portion 78 vol % or more.

Specific examples of the present invention have been described in detail above, but these are merely examples and do not limit the scope of the claims. The technology described in the scope of the claims includes various modifications and changes of the specific examples described above.

### REFERENCE SIGNS LIST

1 Inkjet device
10 Inkjet head
12 Case
13 Storage section
15 Liquid feeding path
16 Discharge section
17 Discharge port
18 Piezo element
20 Guide shaft
30 UV irradiation device
40 Printing cartridge
100 Stirring pulverizer
110 Supply port
120 Stirring vessel
132 Stirring blade
134 Shaft
140 Filter
150 Exhaust port
A Liquid feeding direction
X Axial direction of guide shaft
Y Vertical direction of guide shaft

1. An inkjet ink used for an inorganic base material that is to be baked, the inkjet ink comprising:
an inorganic solid portion including an inorganic pigment and glass; and
a monomer component having a photocurability, wherein
a volume of the inorganic solid portion when a total volume of the inkjet ink is 100 vol % is 30 vol % or less, and
a volume of the glass when a total volume of the inorganic solid portion is 100 vol % is 78 vol % or more.

2. The inkjet ink for an inorganic base material according to claim 1, wherein the volume of the inorganic solid portion when the total volume of the inkjet ink is 100 vol % is 5 vol % or more.

3. The inkjet ink for an inorganic base material according to claim 1, wherein the volume of the glass when the total volume of the inorganic solid portion is 100 vol % is 91 vol % or less.

4. The inkjet ink for an inorganic base material according to claim 1, wherein the monomer component includes at least a monofunctional acrylate monomer containing one acryloyl group or methacryloyl group in a molecule, a monofunctional N-vinyl compound monomer in which one vinyl group bonded to a nitrogen (N) atom of a nitrogen-containing compound, and a polyfunctional vinyl ether-based monomer containing at least two vinyl ether groups in a molecule.

5. The inkjet ink for an organic base material according to claim 4, wherein a volume ratio of the monomer component when the total volume of the inkjet ink is 100 vol % is 44 vol % or more and 85 vol % or less.

6. A method for producing transfer paper for an inorganic base material used for an inorganic base material that is to be baked, the method comprising:
depositing the inkjet ink of claim 4 on a surface of a mount by an inkjet device; and
irradiating the surface of the mount with an ultraviolet ray to cure the inkjet ink deposited on the surface of the mount.

7. A method for producing an inorganic product having a decoration portion, the method comprising:
depositing the inkjet ink of claim 1 on a surface of an organic base material; and
baking the inorganic base material under a condition where a highest baking temperature is set within a range of 500° C. to 1200° C.

8. The inkjet ink for an inorganic base material according to claim 2, wherein the volume of the glass when the total volume of the inorganic solid portion is 100 vol % is 91 vol % or less.

9. The inkjet ink for an inorganic base material according to claim 2, wherein the monomer component includes at least a monofunctional acrylate monomer containing one acryloyl group or methacryloyl group in a molecule, a monofunctional N-vinyl compound monomer in which one vinyl group bonded to a nitrogen (N) atom of a nitrogen-containing compound, and a polyfunctional vinyl ether-based monomer containing at least two vinyl ether groups in a molecule.

10. The inkjet ink for an inorganic base material according to claim 3, wherein the monomer component includes at least a monofunctional acrylate monomer containing one acryloyl group or methacryloyl group in a molecule, a monofunctional N-vinyl compound monomer in which one vinyl group bonded to a nitrogen (N) atom of a nitrogen-containing compound, and a polyfunctional vinyl ether-based monomer containing at least two vinyl ether groups in a molecule.

11. A method for producing transfer paper for an inorganic base material used for an inorganic base material that is to be baked, the method comprising:
depositing the inkjet ink of claim 5 on a surface of a mount by an inkjet device; and
irradiating the surface of the mount with an ultraviolet ray to cure the inkjet ink deposited on the surface of the mount.

12. A method for producing an inorganic product having a decoration portion, the method comprising:
depositing the inkjet ink of claim 2 on a surface of an organic base material; and
baking the inorganic base material under a condition where a highest baking temperature is set within a range of 500° C. to 1200° C.

13. A method for producing an inorganic product having a decoration portion, the method comprising:
depositing the inkjet ink of claim 3 on a surface of an organic base material; and
baking the inorganic base material under a condition where a highest baking temperature is set within a range of 500° C. to 1200° C.

14. A method for producing an inorganic product having a decoration portion, the method comprising:
depositing the inkjet ink of claim 4 on a surface of an organic base material; and
baking the inorganic base material under a condition where a highest baking temperature is set within a range of 500° C. to 1200° C.

15. A method for producing an inorganic product having a decoration portion, the method comprising:
depositing the inkjet ink of claim 5 on a surface of an organic base material; and
baking the inorganic base material under a condition where a highest baking temperature is set within a range of 500° C. to 1200° C.
